(19) United States
(12) Patent Application Publication
(10) Pub. No.: US 2020/0030809 A1
(43) Pub. Date: Jan. 30, 2020

(54) PUMPING AND COMMINUTION DEVICE, METHOD OF COMMINUTING AND HEATING AN INFLOW MATERIAL, AND USE OF SAME

(71) Applicant: INNOIL AG, 7204 Untervaz (CH)

(72) Inventors: KURT BÖHME, VAZ/ OBERVAZ (CH); PIERRE FREYMOND, ZUG (CH)

(73) Assignee: INNOIL AG, 7204 Untervaz (CH)

(21) Appl. No.: 16/495,894

(22) PCT Filed: Mar. 23, 2018
(86) PCT No.: PCT/EP2018/057434

§ 371 Date: Sep. 20, 2019

(30) Foreign Application Priority Data
Mar. 24, 2017 (DE) 10 2017 106 363.3

(51) Int. Cl. B02C 18/00; B01F 13/10; B01F 7/00; F04D 13/08; F04D 29/22; F04D 29/42; F04D 29/62; F04D 7/04; F04D 15/00

(52) U.S. Cl. CPC B02C 18/0092; B01F 13/1041; B01F 7/00733; F04D 13/08; F04D 29/2288; C10G 1/08; F04D 29/628; F04D 7/045; F04D 15/0022; F05D 2250/52; F04D 29/4286

(57) ABSTRACT

A pumping and comminution device is disclosed that includes at least one submersible pump located in a container that is suitable for receiving and inflow material and a drive for driving the submersible pump. In said device, the at least one submersible pump comprises an impeller located in a submersible pump housing, said submersible pump housing having a suction connection for suctioning the inflow material into the submersible pump. Tools are located on the inner face of the submersible pump housing and/or the impeller, allowing solids contained in the inflow material to be comminuted.

The invention relates to a pumping and comminution device, comprising: at least one submersible pump, which is arranged in a container suitable for receiving an inflow material, and a drive for driving the submersible pump and its use.

Furthermore, the invention relates to a method for comminuting and heating an inflow material and its use.

Various methods have been developed according to the prior art for heat input into a liquid mixture of residues (mixed or pure) and other liquids. The heat input by way of a high performance chamber mixer is a very efficient process, but has several disadvantages.

DE 10 2005 056 735 B3 describes a high-performance chamber mixer for catalytic oil suspensions as a reactor for the depolymerization and polymerization of hydrocarbon-containing residues to a middle distillate in circulation. This method and this device have the disadvantage that the high-performance chamber mixer can provide only a slight overpressure of less than 2 bar on the pressure side. Other disadvantages are that the high-performance mixer must be routed via a connecting line from the bearings and seals to a cooling system and the high-performance mixer must be sealed so as to prevent oil mixture from leaking.

DE 10 2012 022 710 A1 describes a mobile plant for the conversion of crude oil, coat, biomass and industrial and municipal waste to a middle distillate with a mixing turbine. A disadvantage of this method and of this device is the complexity of the described vertically designed high-performance chamber mixer. Further disadvantages are that the high-performance mixer requires piping to the separator and that the high-performance mixer must be sealed and painstakingly insulated so as to keep the heat radiation to the outside low.

DE 10 2008 009 647 A1 describes a slurry reactor pump for the simultaneous transport of hot liquids, solids and gases. A disadvantage of this sludge reactor pump is its complexity, its size and the average energy consumption of 120 kW of the drive.

WO 2016/116484 A1 describes a device for catalytic unpressurized oiling where inflow material with an edge length of <40 mm can be used. A disadvantage of this method is that the same high-performance chamber mixer described in the context of the aforementioned method is also used here.

A disadvantage of all the aforementioned methods is the complexity of the piping between the separator and the high-performance mixer and the associated insulation, the size, the weight and the complex seal. Another disadvantage is the grain size to be processed and contamination with metals, glass and stones.

Another disadvantage of the aforementioned method is that the high-performance chamber mixer requires a complex seal due to its complex structure and can only be operated with a slight overpressure of at most 2 bar.

The object of the invention is therefore to provide a device which makes it possible to convey a liquid material mixture and to comminute solids in the material mixture.

The object of the present invention is attained with a pumping and comminution device of the aforementioned type, wherein the at least one submersible pump has an impeller arranged in a submersible pump housing, wherein the submersible pump housing has a suction nozzle for sucking the inflow material into the submersible pump and wherein tools are arranged on the inside of the submersible pump housing and/or on the impeller so that solids contained m the inflow material are comminuted by the tools.

An advantage of the conveyor and comminution device is that the submersible pump circulates the inflow material in the closed, insulated container without requiring additional piping for transporting the inflow material from the container to the submersible pump and back.

By eliminating piping, from and to the submersible pump, and with a certain flow rate in the container, build-up of material or coking occurs neither in the container nor in the submersible pump.

The device allows very efficient filling of a plant with liquid mixture in a very small space, with low acquisition, maintenance and energy costs, wherein solids in the inflow material comminuted simultaneously by the employed tools, and discharge losses, which occur with external comminution and heating of the mixture, be avoided.

Advantageously, a self-priming submersible pump having an impeller is used in a closed container. A propeller enclosed by a ring-shaped or tubular submersible pump housing can be used as an impeller.

The impeller can be installed in the pump housing centrically or eccentrically.

With the pumping and comminuting device, the inflow material is heated from ambient temperature to a temperature of about 400° C. and the solids entrained in the liquid mixture of the starting material are reduced in size by shearing, squeezing and rubbing, without causing the (submersible) pump to be destroyed or clogged.

The inflow material may consist of inorganic as well as organic (hydrocarbon) solids having an edge length of <40 mm, and liquids, such as oils.

The comminution of the solids in the liquid mixture of the inflow material is achieved by using special, durable and easily exchangeable tools and their arrangement in the submersible pump housing.

The inflow material and the pump housing and the exchangeable tools mounted therein are heated by friction.

The pump inflow into the container causes direct heat input into the medium without heal loss.

The tools are preferably flat or jagged and protrude into the interior of the submersible pump housing. The tools are held by compression fittings. Furthermore, clamping tools can be easily mounted on the impeller.

These surfaces preferably have, after the individual clamping tools are mounted, a roughened surface and/or structure. The roughened or structured surfaces can cause friction and comminution, which cause healing of the inflow material.

The tools are preferably arranged interchangeably on the inside of the submersible pump housing. This has the advantage that suitable tools can be mounted for each inflow material and worn tools can be quickly exchanged.

In addition, by selecting a tool having a low friction or a surface with high friction, the friction between the tool, impeller and mixture can be varied, thereby also affecting the degree of comminution and also the heating of the inflow material.

A discharge port is preferably arranged at the opening of the submersible pump housing, with a Venturi nozzle being arranged in the discharge port. With the arrangement of a Venturi nozzle in the discharge port, the inflow material is additionally swirled.

A valve or a gate valve is preferably arranged at the outlet of the discharge port.

The pumping efficiency of the submersible pump as ell as the comminution efficiency can be regulated by the design of the pump housing with the employed tools, the Venturi nozzle and a valve/gate valve.

Preferably, the drive is arranged outside the container. Advantageously, not only the drive (motor), but also the bearings of the submersible pump are arranged gas-tight outside the interior space of the container without making contact with the inflow material.

The bearings and seals are not in contact with the medium, because the bearings and seals are mounted outside the container with the drive.

The object of the present invention is also attained by using the pumping and comminution device as a mixing reactor or in a mixing reactor in a process for the catalytic unpressurized oiling of hydrocarbon-containing inflow material. Such a process for catalytic unpressurized oiling is described, for example, in WO 2016/116484 A1.

An advantage of the pumping and comminution device is that piping from the container to the pump and from the pump to the container is eliminated.

The object of the present invention is also attained by a method of the aforementioned type, wherein the inflow material is pumped through a suction port at the bottom side of the submersible pump in the submersible pump and comminuted and heated by friction by way of tools arranged on the inner wall of the submersible pump housing and/or the impeller. The heat released during comminution passes hereby without heat loss into the carrier medium and inflow material (input material).

The present method is a method of mechanical wet comminution and heating of the inflow material, with the provision that in the self-priming submersible pump, special tools are interchangeably mounted in the interior of the submersible pump housing and/or on the impeller, that the impeller comminutes, swirls and compresses the inflow material in the interior of the pump housing by rotation, whereby the resulting heat is dissipated directly to the inflow material.

With this method, most of the introduced energy is converted into mixing and fractional energy.

The submersible pump preferably pumps the inflow material from a container which is filled with inflow material and in which the submersible pump is arranged.

In addition, the object of the present invention is attained by using the method for comminuting and heating solids of an inflow material in a submersible pump in a system for catalytic unpressurized oiling of hydrocarbon-containing inflow material. Such a process for catalytic unpressurized oiling is described, for example, in WO 2016/116484 A1.

Further details, features and advantages of embodiments of the invention will become apparent from the following description of exemplary embodiments with reference to the accompanying figures. The following:

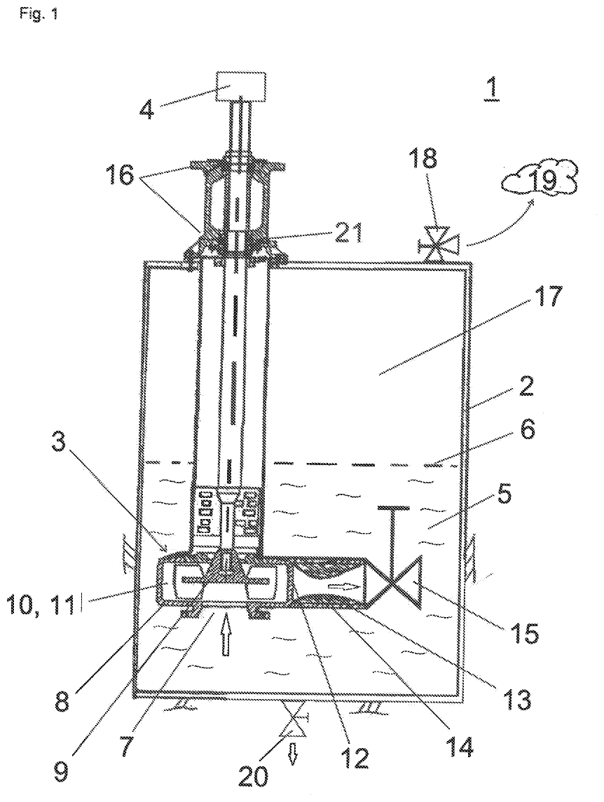

FIG. 1 shows a cross section through a pumping and comminution device according to the invention.

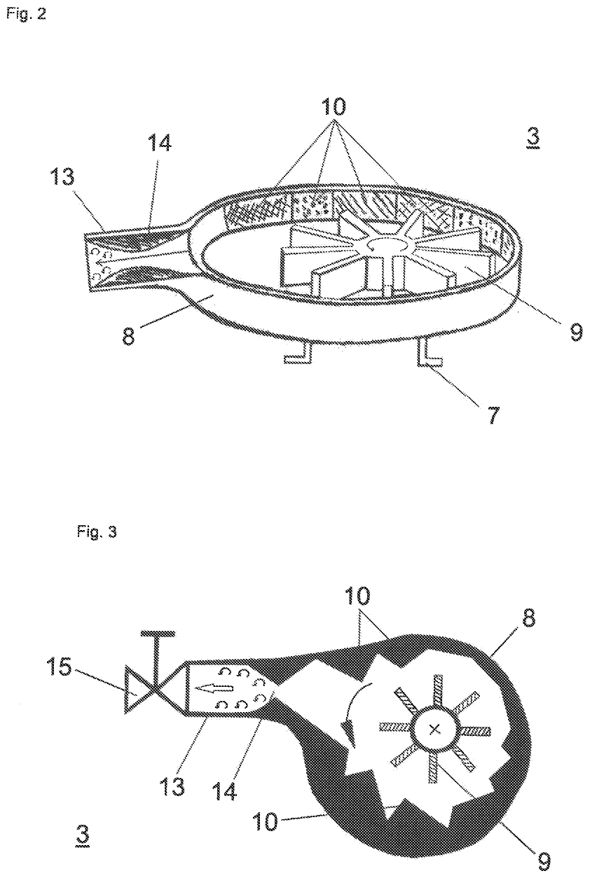

FIG. 2 shows a schematic diagram of the submersible pump with the impeller,

FIG. 3 shows a cross section through the submersible pump.

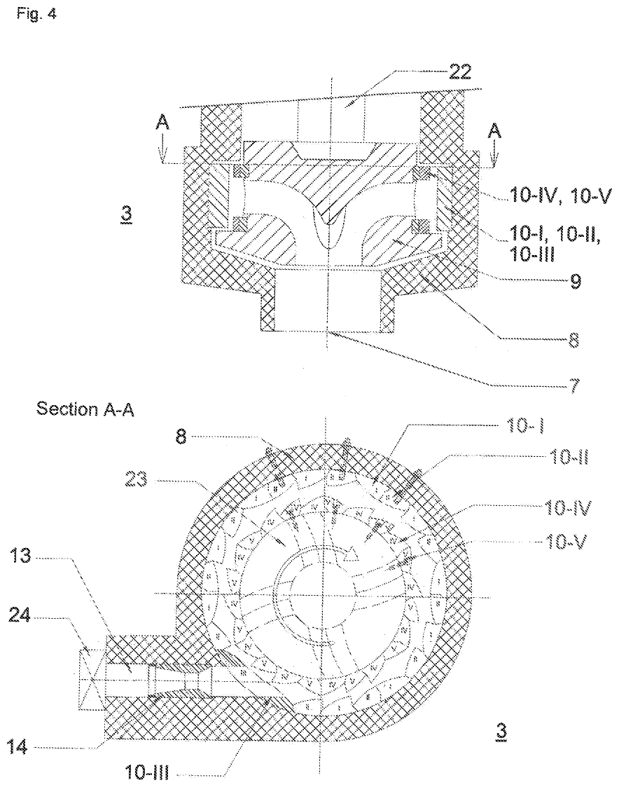

FIG. 4 shows a cross section through the submersible pump with a closed impeller, and

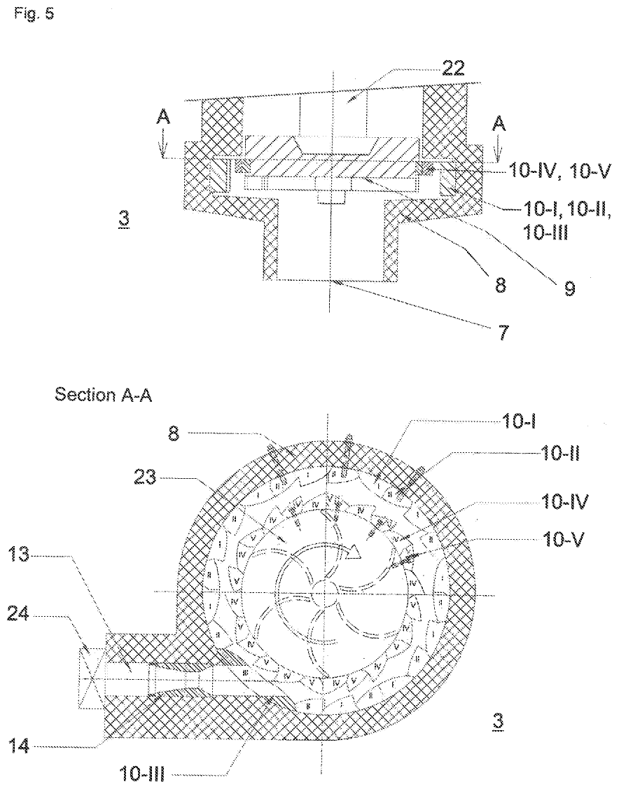

FIG. 5 shows a cross section with a simple impeller and suitable tool attachment.

FIG. 1 shows a pumping and comminution device 1, which is arranged in a closed container 2, with a submersible pump 3 and a drive 4 for the submersible pump 3.

The container 2 of the pumping and comminution device 1 shown in FIG. 1 is partially filled with an inflow material 5. The submersible pump is arranged below the liquid level 6, so that the inflow material 5 can flow into the pump through a suction port 7. An impeller 9 constructed to guide the inflow material 5 past the tools 10 disposed on the inner wall 11 of the submersible pump housing 8 is arranged in the submersible pump housing 8 of the submersible pump 3. The solids entrained in the inflow material 5 are mechanically comminuted, swirled, finely grated, compressed and heated by the rotation of the impeller 9 and the tools 10. The generated heat is transferred without loss to the liquid mixture.

The submersible pump 3 has a lateral opening 12, through which the inflow material 5 is pumped into a discharge port 13, in which a Venturi nozzle 14 is arranged. The output of the discharge port 13 has a valve 15 or a gate valve. The valve 15 and the gate valve can be used to raise or tower the pressure in the submersible pump 3.

The temperature in the mixture can be raised or lowered by regulating the pressure via the valve 15 or the gate valve. When the valve 15 or the gate valve is closed, the pressure in the submersible pump housing 8 and hence also the temperature increase. Opening the valve 15 or the gate valve causes the pressure and thus also the temperature in the submersible pump housing 8 to decrease.

The residence time of the inflow material 5 in the submersible pump housing 8 can also be shortened or extended by the valve 15 and the gate valve

The (pump) drive 4 and the bearing 16 of the submersible pump 3 are arranged outside the interior space of the container without making contact with the inflow material 5 and in a gas-tight manner by means of a seal 21 to the container interior space 17.

The uncontaminated or contaminated, mixed inflow material 5, such as organic and inorganic compounds (wood, bones, plastics, but also glass, ceramics, metals, etc.) with an edge length of ≤40 mm, is introduced into the container 2 through a valve 18 and processed by the pump. In addition, the valve 18 (for example, a 3-way valve) is used to vent steam 19.

Another valve 20 for emptying the container 2 is disposed on the bottom side of the container 2.

Organic mixtures can be processed to a size of ≤80 μm, depending on the degree of contamination and/or residence time in the container 2 and in the submersible pump 3.

FIGS. 2 and 3 show the submersible pump 3 constructed as a self-priming pump of the pumping and comminution device 1 for mechanical wet comminution and for heating an inflow material 5.

The submersible pump 3 is a pump wheel arranged eccentrically in the submersible pump housing 8 with an axially arranged suction port 7, a radially arranged discharge port 13, a valve 15 or a gate valve, and an Integrated Venturi nozzle 14.

The pump housing interior of the submersible pump 3 and/or the impeller 9 are lined with various tools 10 of different size and shape so that the inflow material 5 containing oil and other materials is comminuted and simultaneously heated. The inflow material 5 is circulated in the closed container 2 from the submersible pump 3 via an integrated Venturi nozzle 14 in the discharge port 13 and a valve 15 or a gate valve at the outlet of (he discharge port.

The Venturi nozzles 14 cause turbulence in the discharge port 13, which mixes the inflow material 5.

Depending on requirements, one or more submersible pumps 3 may be arranged in a container 2 and used.

The pumping and comminution device 1 and the method for comminuting and heating an inflow material 5 make it possible to use, without any problem, an inflow material 5 containing hydrocarbon-residues from agriculture and forestry or contaminated household and/or industrial waste products with large fractions of stones, glass or metals up to a size of 40 mm with oil or other liquids.

FIGS. 4 and 5 show cross sections of submersible pumps 3 according to the invention.

The top part of FIG. 4 shows at a cross section through a submersible pump 3 with a closed impeller 9, and the bottom part of FIG. 4 shows a cross section along the line A-A through the submersible pump 3 with a gate valve 24 shown in the top part of FIG. 4.

The closed impeller 9 is arranged in the submersible pump housing 8 and is driven by a drive 4 (motor), not shown in the FIG. 4, via a drive shaft 22.

In the cross section shown in the bottom part of FIG. 4 on the line A-A through the submersible pump 3, tools 10 are shown, which are arranged on the inside of the submersible pump housing 8 and on an impeller 23. The attachment of the tools 10 varies, so that the tools 10 can be attached either clamped (tools 10-I, 10-III, 10-IV) or screwed together (tools 10-II, 10-V).

As shown in FIG. 4 (top), the tools 10-IV and 10-V are disposed inside on the closed impeller 9 (or the impeller 23, respectively). The tools 10-I, 10-II and 10-III are attached outside on the submersible pump housing 8, or on the inner wall of the submersible pump housing 8.

The tools 10 are made of a hard, abrasion-resistant material, such as metal, and are shaped so as to extend from the Inside of the submersible pump housing 8 irregularly in the direction of the impeller 9, and/or form the impeller 9 toward the inner wall of the submersible pump housing 8, so that the material to be comminuted located in the interior space 11 of the submersible pump 3 is crushed between the tools 10 and thus comminuted.

FIG. 5 shows a cross section through a submersible pump 3 with a simple impeller 9.

The arrow shown in FIGS. 4 and 5 indicates the direction of rotation of the impeller 9.

### LIST OP REFERENCE NUMBERS

1 pumping and comminution device
2 container
3 submersible pump
4 drive, pump drive (motor)
5 inflow material
6 fluid levels
7suction port, intake port
8 submersible pump housing
9 impeller
10 tool
10-I Tool I (clamped)
10-II Tool II (screwed)
10-III Tool III (clamped)
10-IV Tool IV (clamped)
10-V Tool V (screwed)
11 interior space (of the submersible pump 3)
12 opening
13 discharge port
14 Venturi nozzle
15 valve
16 bearing
17 container interior
18 valve
19 steam
20 valve
21 seal (of the shaft)
22 drive shaft
23 impeller
24 gate valve

1-11. (canceled)

12. A pumping and comminution device, comprising:
a submersible pump arranged in a container for receiving an inflow material,
a drive for driving the submersible pump, wherein said pump comprises an impeller arranged in a submersible pump housing, wherein said pump housing has a suction port for sucking the inflow material into the pump and wherein comminution tools are arranged on the inside of the pump housing or arranged on the impeller so that solids entrained in the inflow material are comminuted by the tools.

13. The device according to claim 12, wherein the tools are configured flat or jagged and protrude into the interior of the submersible pump housing.

14. The device according to claim 13, wherein the tools have a roughened surface and/or have a structured surface.

15. The device according to 12, wherein the tools arranged on the inside of the submersible pump housing are exchangeable.

16. The device according to claim 12, wherein a discharge port is arranged at an opening of the pump housing and wherein a Venturi nozzle is arranged in the discharge port.

17. The device according to claim 12, wherein a valve or a gate valve is arranged at an outlet of the discharge port.

18. The device according to claim 12, wherein the drive is arranged outside of the container.

19. A method of using the pumping and comminution device according to claim 12 comprising, using the device as a mixing reactor or in a mixing reactor in a method for catalytic unpressurized depolymerization of hydrocarbons in an inflow material.

20. A method for comminuting and heating an inflow material, comprising the steps of:
pumping the inflow material into a submersible pump through a suction nozzle disposed at a bottom side of the pump, said pump including an impeller,
comminuting the Inflow material by tools arranged on an inner wall of a pump housing and/or on the impeller wherein the inflow material is heated by friction generated by the comminution.

21. The method according to claim 20, further comprising that the pump is pumping the inflow material from a container which is filled with inflow material and in which the submersible pump is arranged.

22. The method of using the process of claim 21, comprising carrying out the comminuting and heating in a plant suitable for the catalytically unpressurized depolymerization of hydrocarbon-containing inflow material (5).
